(19) United States
(12) Patent Application Publication
(10) Pub. No.: US 2008/0061525 A1
(43) Pub. Date: Mar. 13, 2008

(54) VEHICULAR WHEEL ASSEMBLY

(75) Inventors: Terence G. Ward, Redondo Beach, CA (US); James M. Nagashima, Cerritos, CA (US); Michael Milani, Rancho Palos Verdes, CA (US); Khwaja M. Rahman, Troy, MI (US)

Correspondence Address: INGRASSIA FISHER & LORENZ, P.C. (GM), 7150 E CAMELBACK ROAD, SUITE 325, SCOTTSDALE, AZ, 85251, US

(73) Assignee: GM GLOBAL TECHNOLOGY OPERATIONS, INC., DETROIT, MI (US)

(21) Appl. No.: 11/852,273

(22) Filed: Sep. 7, 2007

Related U.S. Application Data
(60) Provisional application No. 60/843,138, filed on Sep. 8, 2006.

(51) Int. Cl. B62D 7/16

(52) U.S. Cl. 280/93.508

(57) ABSTRACT

A vehicular wheel assembly includes a first bearing component configured to be coupled to a frame of a vehicle, a second bearing component rotatably coupled to the first bearing component, and a brake mechanism coupled to the second bearing component. The motor includes a stator and a rotor. The stator is coupled to the first bearing component and the rotor is coupled to the second bearing component such that rotation of the rotor relative to the stator causes the second bearing component to rotate relative to the first bearing component. The brake mechanism is between the motor and the frame and is configured to slow the rotation of the second bearing component and the rotor.

### CROSS REFERENCE TO RELATED APPLICATION

This application claims priority to U.S. Provisional Application Ser. No. 60/843,138 filed Sep. 8, 2006, which is hereby incorporated by reference in its entirety.

### TECHNICAL FIELD

The present invention generally relates to vehicles, such as automobiles, and more particularly relates to a vehicular wheel assembly including a motor.

### BACKGROUND OF THE INVENTION

In recent years, advances in technology, as well as ever evolving tastes in style, have led to substantial changes in the design of automobiles. One of the changes involves the complexity of the electrical and drive systems within automobiles, particularly alternative fuel vehicles, such as hybrid, electric, and fuel cell vehicles. Such alternative fuel vehicles typically use an electric motor, perhaps in combination with another means of propulsion, to drive the wheels.

As the power demands on the electrical systems in alternative fuel vehicles continue to increase, there is an ever increasing need to maximize the electrical, as well as the mechanical, efficiency of such systems. Additionally, there is a constant desire to reduce the number components required to operate alternative fuel vehicles and minimize the overall cost and weight of the vehicles.

Recently attempts have been made to develop workable “wheel motor” systems in which the electric motors are placed near, or essentially within, the wheels they are intended to drive. Using such systems, it may be possible to reduce, perhaps even eliminate, the need for any sort of transmission or drive line that couples the electric motor to the wheel. Thus, wheel motors have the potential to both increase mechanical efficiency and reduce the number of components. However, present current designs for wheel motors have been found to be undesirable due to the considerable mass that must be added to the wheel assembly to incorporate the motor, increased axial dimensions, greater system complexity, the necessity for expensive custom components, and decrease is suspension attachment freedom.

Accordingly, it is desirable to provide a wheel assembly that incorporates a motor and allows for a reduced number of components and system complexity and the use of standard automotive components. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

In one embodiment, a wheel assembly configured to be coupled to a frame of a vehicle is provided. The wheel assembly includes a first bearing component configured to be coupled to the frame, a second bearing component rotatably coupled to the first bearing component, and a brake mechanism coupled to the second bearing component. The motor includes a stator and a rotor. The stator is coupled to the first bearing component and the rotor is coupled to the second bearing component such that rotation of the rotor relative to the stator causes the second bearing component to rotate relative to the first bearing component. The brake mechanism is between the motor and the frame and is configured to slow the rotation of the second bearing component and the rotor.

In another embodiment, a wheel assembly configured to be coupled to a frame of a vehicle is provided. The wheel assembly includes a stationary bearing component, a shaft rotatably coupled to the stationary bearing component and having a first end and a second end, a motor including a stator and a rotor, and a brake mechanism. The stator is coupled to the stationary bearing component and the rotor is coupled to the first end of the shaft such that rotation of the rotor relative to the stator causes the shaft to rotate. The brake mechanism is coupled to the second end of the shaft to slow the rotation of the shaft and the rotor.

In a further embodiment, a wheel assembly configured to be coupled to a frame of a vehicle is provided. The wheel assembly includes a stationary bearing component configured to be coupled to the frame, a shaft coupled to the stationary bearing component to rotate about an axis and having a first end and a second end, a motor including a stator and a rotor, the stator being coupled to the stationary bearing component and the rotor being coupled to the first end of the shaft such that rotation of the rotor relative to the stator causes the shaft to rotate, the motor having first and second portions on opposing sides of the axis, a wheel coupled to the shaft such that rotation of the shaft causes the wheel to rotate, and a brake mechanism coupled to the second end of the shaft and being between the motor and the frame to slow the rotation of the shaft, the rotor, and the wheel.

### DESCRIPTION OF THE DRAWINGS

The present invention will hereinafter be described in conjunction with the following drawing figures, wherein like numerals denote like elements, and

FIG. 1 is a schematic view of an exemplary automobile according to one embodiment of the present invention;

FIG. 2 is a cross-sectional view of a wheel assembly on the automobile of FIG. 1; and

FIG. 3 is a cross-sectional view of the wheel assembly of FIG. 2 with several components thereof removed.

### DESCRIPTION OF AN EXEMPLARY EMBODIMENT

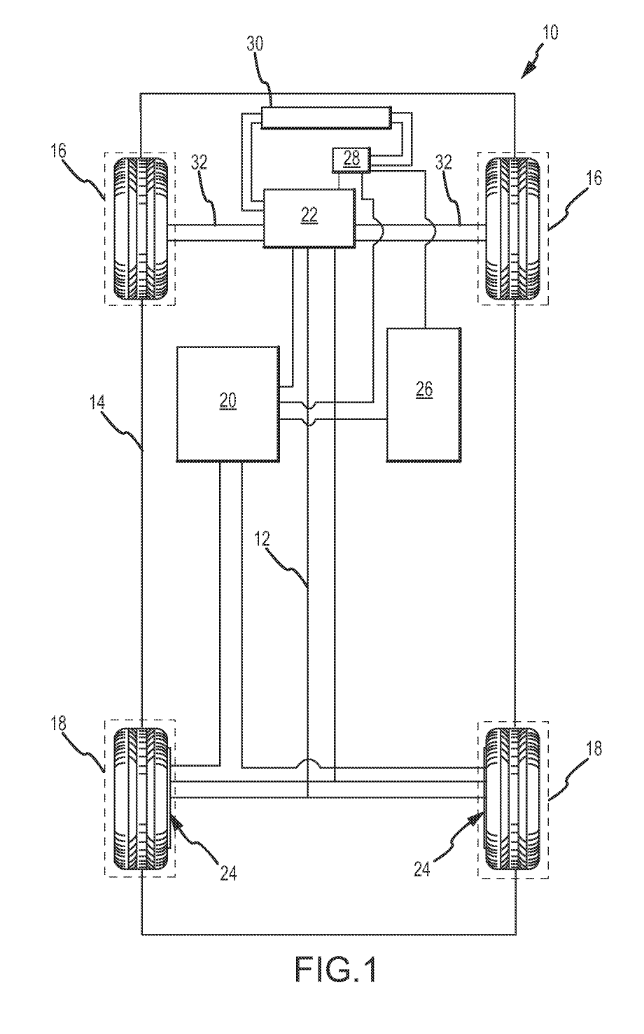

The following detailed description is merely exemplary in nature and is not intended to limit the invention or the application and uses of the invention. Furthermore, there is no intention to be bound by any expressed or implied theory presented in the preceding technical field, background, brief summary or the following detailed description. Additionally, although the schematic diagrams shown herein depict example arrangements of elements, additional intervening elements, devices, features, or components may be present in an actual embodiment. It should also be understood that FIGS. 1-3 are merely illustrative and may not be drawn to scale.

FIG. 1 to FIG. 3 illustrate a wheel assembly, or wheel motor, according to one embodiment of the present invention. The wheel assembly includes a first bearing component configured to be coupled to a frame of a vehicle, a second bearing component rotatably coupled to the first bearing component, and a brake mechanism coupled to the second bearing component. The motor includes a stator and a rotor. The stator is coupled to the first bearing component and the rotor is coupled to the second bearing component such that rotation of the rotor relative to the stator causes the second bearing component to rotate relative to the first bearing component. In one embodiment, the brake mechanism is between the motor and the frame and is configured to slow the rotation of the second bearing component and the rotor. In another embodiment, the second bearing component is a shaft and the rotor and the brake mechanism are connected to opposing ends of the shaft.

FIG. 1 illustrates a vehicle 10, or “automobile,” according to one embodiment of the present invention. The automobile 10 includes a chassis 12, a body 14, two front wheels 16, two rear wheels 18, and an electronic control system (or electronic control unit (ECU)) 20. The body 14 is arranged on the chassis 12 and substantially encloses the other components of the automobile 10. The body 14 and the chassis 12 may jointly form a frame. The wheels 16 and 18 are each rotationally coupled to the chassis 12 near a respective corner of the body 14.

The automobile 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 10 may also incorporate any one of, or combination of, a number of different types of engines (or actuators), such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, or a fuel cell, a combustion/electric motor hybrid engine, and an electric motor.

In the exemplary embodiment illustrated in FIG. 1, the automobile 10 is a hybrid vehicle, and further includes an internal combustion engine 22, wheel motors (or wheel assemblies) 24, a battery 26, a power inverter (or inverter) 28, and a radiator 30. The internal combustion engine 22 is mechanically coupled to the front wheels 16 through drive shafts 32 through a transmission (not shown). As will be described in greater detail below, each of the wheel motors 24 is housed within one of the rear wheel assemblies 18. The battery 26 is coupled to the electronic control system 20 and the inverter 28. The radiator 30 is connected to the frame at an outer portion thereof and although not illustrated in detail, includes multiple cooling channels therethough that contain a cooling fluid (i.e., coolant) such as water and/or ethylene glycol (i.e., “antifreeze”) and is coupled to the engine 22 and the inverter 28. Although not illustrated, the power inverter 28 may include a plurality of switches, or transistors, as is commonly understood.

The electronic control system 20 is in operable communication with the engine 22, the wheel motors 24, the battery 26, and the inverter 28. Although not shown in detail, the electronic control system 20 includes various sensors and automotive control modules, or electronic control units (ECUs), such as an inverter control module and a vehicle controller, and at least one processor and/or a memory which includes instructions stored thereon (or in another computer-readable medium) for carrying out the processes and methods as described below.

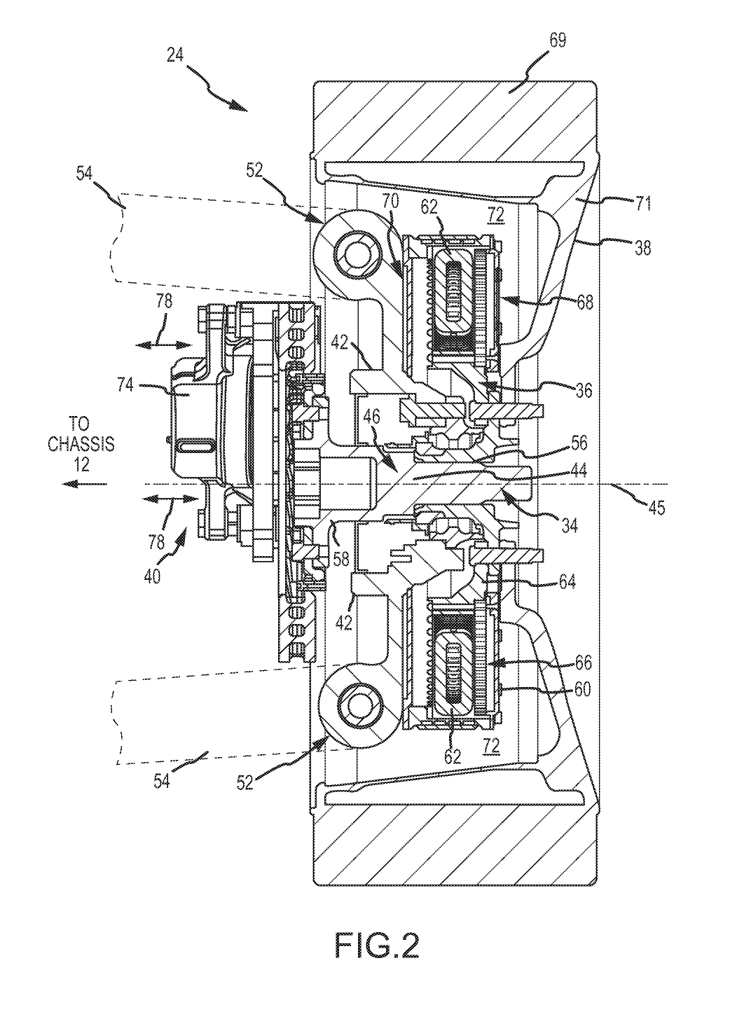

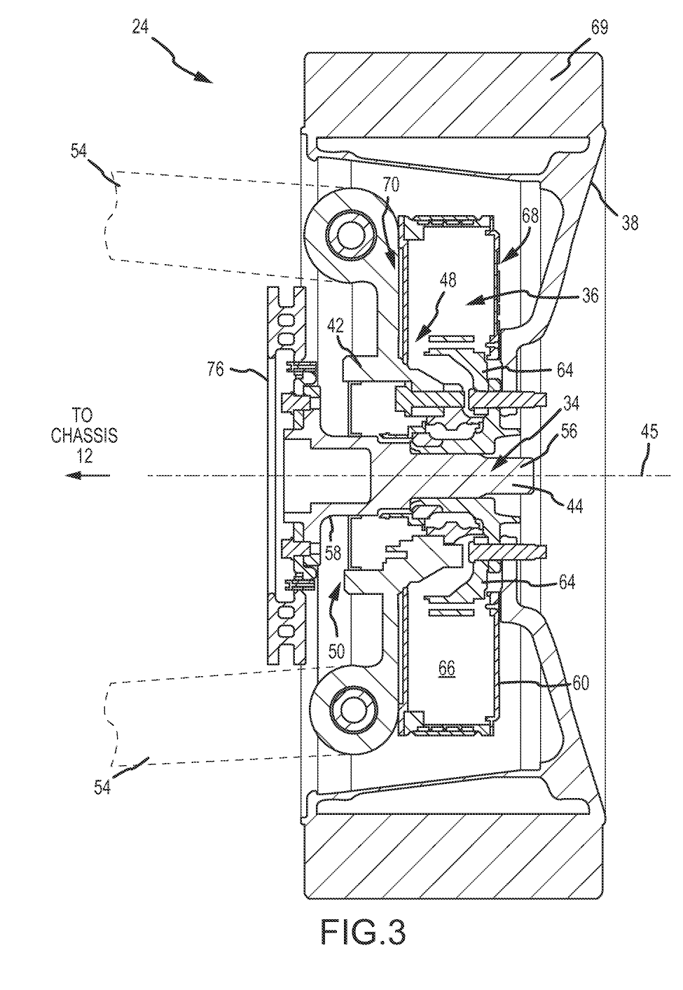

FIGS. 2 and 3 are cross-sectional views illustrating one of the rear wheel assemblies 18 (or wheel motors 24) in greater detail. The rear wheel assembly 18 includes a bearing 34, a motor 36, a wheel 38, and a brake mechanism (or subassembly) 40.

The bearing 34 includes an outer (or first) component (or stationary bearing component) 42 and an inner (or second) component (or shaft) 44. The outer component 42, in the depicted embodiment, is substantially annular about an axis 45 with an opening 46 extending therethrough and has an outer (or first) side 48 opposing the chassis 12 (or frame) of the vehicle 10 and an inner (or second) side 50) adjacent (or near) the chassis 12. As shown, the outer component 42 includes multiple (e.g., two) ball joints 52 (or frame connectors) extending therefrom in a direction substantially perpendicular to the axis 45. Each of the ball joints 52 may be connected to an arm 54 (e.g., an “A-arm”), which in turn is connected to the chassis 12.

The inner component (or brake shaft) 44 extends through the opening 46 in the outer component 42 and in connected, or coupled, to the outer component 42 in such a way that it may freely rotate relative to the outer component 42. Although not shown, the rotation of the inner component 44 relative to the outer component 42 may be assisted by rolling elements positioned directly between the outer and inner components 42 and 44. The inner component 44 has an outer (or first) portion (or end) 56 opposing the chassis 12 and an inner (or second) portion 58 adjacent to the chassis 12.

Still referring to FIGS. 2 and 3, the motor (and/or generator) 36 includes a housing (or casing) 60, a stator (or stator assembly) 62, and a rotor (or rotor assembly) 64. In the depicted embodiment, the housing 60 is substantially disk-shaped and encloses a similarly shaped cavity 66. The housing 60 has an outer (or first) side (and/or wall) 68 and an inner (or second) side (and/or wall) 70. As shown, the housing 60 surrounds the outer portion 56 of the inner component 44 of the bearing 34 and thus, as shown, has first and second portions on opposing sides of the outer portion 56 of the inner component 44. In the depicted embodiment, the outer and inner walls 68 and 70 of the housing extend substantially perpendicularly from the axis 45. The housing 60 is connected to the outer component 42 of the bearing 34, and the inner walls 70 of the housing 60 are in contact with and/or connected to outer sides of the ball joints 52. As such, the housing 60 of the motor 36 is rotationally fixed to the outer component 42 of the bearing 34.

The stator 62 is connected to, and located within the cavity 66 of, the housing 60. The stator 62 has a substantially annular shape with an opening at a central portion thereof and surrounds the outer portion 56 of the inner component 44 of the bearing, as well as the axis 45. Although not illustrated in detail, the stator 62 includes, in one embodiment, one or more ferromagnetic cores and one or more conductive windings, or coils, wrapped around the cores. Because the stator 62 is connected to the housing 60, which is connected to the outer component 42 of the bearing 34, the stator is rotationally fixed to the outer component 42 of the bearing 34.

The rotor 64, in one embodiment, is at least partially located within the cavity 66 of the housing 60 and the opening through the stator 62. The rotor is rotationally coupled, or connected, to the outer portion 56 of the inner component 44 of the bearing 34. In one embodiment, the rotor 64 includes one or more magnets (e.g., sixteen magnets) arranged, for example, on two disks in an axial flux configuration, as is commonly understood in the art.

In the depicted embodiment, the wheel 38 is substantially circular and includes an annular outer portion, or rim, 69 and a substantially disk-shaped central portion 71 connected to an outer edge of the rim 69. The central portion 71 of the wheel 38 extends inward from the rim 69 and is secured to, or rotationally coupled to, the rotor 64 of the motor 36 and/or the inner component 44. In the depicted embodiment the wheel 38 is connected in a direct drive configuration in which one rotation of the inner component 44 causes one rotation of the wheel 38.

The rim 69 surrounds the axis 45 such that, as shown, first and second portions lie on opposing sides of the axis 45. A wheel cavity 72 is formed on an inner side (i.e., adjacent or near the chassis 12) of the central portion 71 and between the first and second portions of the rim. In the embodiment shown, the entire outer component 42 of the bearing 34, including the ball joints 52, and the motor 36 are within the wheel cavity 72.

Still referring to both FIGS. 2 and 3, the brake mechanism 40 includes a caliper (or first member) 74 and a brake rotor or disk (or second member) 76. Although not specifically shown, the caliper 74 is coupled or fixed to (and/or connected to) the outer component 42 of the bearing 34 and is positioned between the motor 36 and the frame. As indicated by arrows 78, the caliper 74 is also moveable between first and second positions in a direction substantially parallel to the axis 45. As shown specifically in FIG. 3, the brake rotor 76 is rotationally coupled to (or connected to) the inner portion 58 of the inner component 44 of the bearing 34. In the depicted embodiment, the brake rotor 76 is substantially disk-shaped and centered on the axis 45. Referring again to FIGS. 2 and 3, the caliper 74 and the brake rotor 76 are positioned such that when the caliper 74 is moved from the first to the second position, the caliper 74 contacts, and applies a force onto, the brake rotor 76.

Of particular interest in the embodiment illustrated in FIGS. 2 and 3, are the relative positions of, and connections made between, the chassis 12, the brake mechanism 40, the motor 36, and the wheel 38. In particular, the chassis 12 is only connected to the motor 36 on the inner side 70 of the motor 36, and the wheel 38 is only connected to the motor 36 on the outer side 68 of the motor 36.

During operation, still referring to FIG. 1, the vehicle 10 is operated by providing power to the front wheels 16 with the combustion engine 22 and the rear wheels 18 with the wheel motors 24 in an alternating manner and/or simultaneously. In order to power the wheel motors 24 (or motors 36), direct current (DC) power is provided from the battery 26 to the inverter 28, which converts the DC power into alternating current (AC) power, before the power is sent to the wheel motors 24. As will be appreciated by one skilled in the art, the conversion of DC power to AC power is substantially performed by operating (i.e., repeatedly switching) the switches 4 within the inverter 28.

Referring to FIG. 2, as is commonly understood, as current flows through the windings in the stator 62 of the motor 36, a Lorentz force is generated between the stator 62 and the rotor 64 that causes the rotor 64 to rotate relative to the stator 62 about the axis 45. Because of the connections described above, this rotation also causes the inner component 44 of the bearing 34, as well as the wheel 38 and the brake rotor 76 (FIG. 3), to rotate relative to the outer component 42 of the bearing 34, the chassis 12, and the caliper 74 of the brake mechanism 40. Thus, the vehicle 10 is propelled. In order to slow or stop the rotation of the wheel 38, as well the movement of the vehicle 10, the caliper 74 may be moved (via an input from a user of the vehicle 10) into the second position to apply a force onto the brake rotor 76, thus increasing creating additional friction on the inner component 44 of the bearing 34. The motor 36 may also be used a generator, as is commonly understood, which may further assist in slowing the rotation of the wheel 38.

One advantage of the wheel assembly described above is that a compact wheel motor solution with an integrated friction brake system is provided. Because the brake rotor and caliper are located on the inboard (or inner) side of the motor and non-rotating side of the hub bearing and the brake rotor is coupled to the motor by a brake shaft located at the center axis, all of the structural elements for motor mounting, handling of reaction torque, and brake caliper mounting may be shared on one common side of the motor.

In a conventional automobile wheel assembly, the brake rotor mount is located on the outboard side of the hub bearing just inside the wheel where the rotating elements (e.g., wheel, brake rotor, and rotating component of bearing) are grouped together. The wheel assembly described above eliminates the additional mass and considerable structural elements that are included in conventional, outboard (i.e., outer side) mounted friction braking systems in which the rotating elements are grouped together on the outboard side of the hub bearing. That is, in conventional wheel motor systems, because the friction brake caliper and rotor are mounted on the outboard side of the hub bearing, the braking loads are often transferred through the motor to the chassis or a larger wheel is required, thus adding mass to the system. The system described above is thus provides a considerably simplified architecture for mounting a wheel motor and friction brake system inside a wheel.

Other embodiments may utilize the method and system described above in implementations other than automobiles, such as aircraft. The wheel assembly described above may be used on any, or all, of the wheels of the vehicle (i.e., front and/or rear). The components within the motor may be rearranged such that the components within the stator and rotor are reversed (i.e., the windings may be on the rotor, etc). Other forms of power sources may be used, such as current sources and loads including diode rectifiers, thyristor converters, fuel cells, inductors, capacitors, and/or any combination thereof.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A wheel assembly configured to be coupled to a frame of a vehicle, the wheel assembly comprising:
a first bearing component configured to be coupled to the frame;
a second bearing component rotatably coupled to the first bearing component;
a motor comprising a stator and a rotor, the stator being coupled to the first bearing component and the rotor being coupled to the second bearing component such that rotation of the rotor relative to the stator causes the second bearing component to rotate relative to the first bearing component; and
a brake mechanism coupled to the second bearing component and positioned between the motor and the frame to slow the rotation of the second bearing component and the rotor.

2. The wheel assembly of claim 1, wherein the second bearing component has an outer portion opposing the frame and an inner portion adjacent to the frame, and wherein the rotor of the motor is coupled to the outer portion of the second bearing component.

3. The wheel assembly of claim 2, wherein the brake mechanism comprises first and second members, the first member being coupled to the first bearing component and the second member being coupled to the inner portion of the second bearing component.

4. The wheel assembly of claim 3, wherein the motor has first and second portions on opposing sides of the outer portion of the second bearing component.

5. The wheel assembly of claim 4, wherein the motor has outer and inner sides, the brake mechanism being on the inner side of the motor, and the stator is not coupled to the first bearing component through the outer side of the motor.

6. The wheel assembly of claim 5, further comprising a wheel coupled to the rotor of the motor such that rotation of the rotor relative to the stator causes the wheel to rotate relative to the frame.

7. The wheel assembly of claim 6, wherein the wheel is not coupled to the rotor through the inner side of the motor.

8. The wheel assembly of claim 7, wherein the rotor is coupled to the second bearing component such that one rotation of the rotor relative to the stator causes one rotation of the second bearing component relative to the first bearing component.

9. The wheel assembly of claim 8, wherein the stator is coupled to the frame only through the inner side of the motor and the rotor is coupled to the wheel only through the outer side of the motor.

10. The wheel assembly of claim 9, wherein the wheel comprises a wheel cavity and the motor is positioned entirely within the wheel cavity.

11. A wheel assembly configured to be coupled to a frame of a vehicle, the wheel assembly comprising:
a stationary bearing component;
a shaft rotatably coupled to the stationary bearing component and having a first end and a second end;
a motor comprising a stator and a rotor, the stator being coupled to the stationary bearing component and the rotor being coupled to the first end of the shaft such that rotation of the rotor relative to the stator causes the shaft to rotate; and
a brake mechanism coupled to the second end of the shaft to slow the rotation of the shaft and the rotor.

12. The wheel assembly of claim 11, wherein the stationary bearing component is configured to be coupled to the frame of the vehicle and the brake mechanism is positioned between the motor and the frame.

13. The wheel assembly of claim 12, wherein the brake mechanism comprises first and second members, the first member being coupled to the stationary bearing component and the second member being coupled to the second end of the shaft.

14. The wheel assembly of claim 13, wherein the motor has first and second portions on opposing sides of the first end of the shaft.

15. The wheel assembly of claim 14, wherein the motor has outer and inner sides, the brake mechanism being on the inner side of the motor, and the stator is not coupled to the stationary bearing component through the outer side of the motor.

16. The wheel assembly of claim 15, further comprising a wheel coupled to a rotor of the motor such that rotation of the rotor relative to the stator causes the wheel to rotate relative to the frame.

17. The wheel assembly of claim 16, wherein the stator is coupled to the frame only through the inner side of the motor and the rotor is coupled to the wheel only through the outer side of the motor.

18. A wheel assembly configured to be coupled to a frame of a vehicle, the wheel assembly comprising:
a stationary bearing component configured to be coupled to the frame;
a shaft coupled to the stationary bearing component to rotate about and axis and having a first end and a second end;
a motor comprising a stator and a rotor, the stator being coupled to the stationary bearing component and the rotor being coupled to the first end of the shaft such that rotation of the rotor relative to the stator causes the shaft to rotate, the motor having first and second portions on opposing sides of the axis;
a wheel coupled to the shaft such that rotation of the shaft causes the wheel to rotate; and
a brake mechanism coupled to the second end of the shaft and positioned between the motor and the frame to slow the rotation of the shaft, the rotor, and the wheel.

19. The wheel assembly of claim 18, wherein the motor has outer and inner sides, the brake mechanism being on the inner side of the motor, and the stator is not coupled to the stationary bearing component through the outer side of the motor.

20. The wheel assembly of claim 19, wherein the stator is coupled to the frame only through the inner side of the motor and the rotor is coupled to the wheel only through the outer side of the motor.
